(19) United States
(12) Patent Application Publication
(10) Pub. No.: US 2008/0080056 A1
(43) Pub. Date: Apr. 3, 2008

(54) Method and apparatus for reducing microlens surface reflection

(75) Inventors: Jin Li, Boise, ID (US); Jiutao Li, Boise, ID (US); Ulrich Boettiger, Boise, ID (US)

Correspondence Address: DICKSTEIN SHAPIRO LLP, 1825 EYE STREET, NW, WASHINGTON, DC, 20006, US

(73) Assignee: Micron Technology, Inc.

(21) Appl. No.: 11/511,206

(22) Filed: Aug. 29, 2006

(51) Int. Cl. G02B 27/10

(52) U.S. Cl. 359/620

(57) ABSTRACT

A microlens has a surface with an effective index of refraction closer to the index of air than the body of the microlens to reduce reflection. Fibers protrude vertically from the surface of a microlens. For fabrication, the fibers are propelled at an adhesive layer provided over a microlens body and subjected to an electric field so that they stand vertically on the surface of the microlens. The adhesive layer is cured to hold the fibers in place.

### FIELD OF THE INVENTION

Embodiments of the invention relate generally to a microlens for use in an imager device.

### BACKGROUND OF THE INVENTION

Microlenses are typically used to funnel light of a larger area into a photosensor of an imager device pixel. When light passes through two media, such as air and a lens, the propagation is based on the relationship between the refractive indices of the two media. Snell's Law (Eq. 1) relates the indices of refraction n of the two media to the directions of propagation in terms of angles to the normal:

n₁ sin θ₁=n₂ sin θ₂ (1)

The index of refraction (n) is defined as the speed of light in vacuum (c) divided by the speed of light in a medium (v), as represented by Eq. 2:

n=c/v (2)

The refractive index of air is 1.000277. Representative materials used in microlens fabrication include photoresist polymer with a refractive index of about 1.6, silicon dioxide with a refractive index of about 1.45, and silicon nitride with a refractive index of about 2.0. Accordingly, there is a large disparity between the refractive indices at the air-microlens interface. FIG. 1a illustrates the relationship between the indices of refraction at the air-microlens interface. The graph on the right side of FIG. 1a shows a constant index of refraction in air and a different constant index of refraction at all depths of the microlens, and therefore a sharp increase in the index of refraction at the air-microlens interface.

When light travels from a medium with a low refractive index, such as air, to a medium with a high refractive index (the incident medium), e.g., silicon nitride, the angle of light with respect to the normal will increase. In addition, some light will be reflected. This will reduce the efficiency of the imaging system, since not all of the light hitting the lens will travel through the lens to the photodiode, for example.

Reflection at the interface of two different media can be quantified by the following formula (Eq. 3):

R=(n₁−n₂)²/(n₁+n₂)² (3)

Therefore, reflection at the interface between the two media can be reduced by matching their indices of refraction as closely as possible. As noted above, the refractive index of silicon dioxide (1.45) is significantly closer to 1.0, the refractive index of air, than that of silicon nitrides (2.0). By providing an outer layer on a microlens having an index of refraction closer to that of the surrounding medium, such as that of air, reflection is reduced and the efficiency and accuracy of the lens is improved.

FIG. 1b illustrates the relationship between the indices of refraction at the air-microlens interface, where the microlens has an outer layer which reduces the index of refraction of a microlens. The graph on the right side of FIG. 1b shows an index of refraction varying at varying depths of the microlens, and therefore a gradual increase in the index of refraction at the air-microlens interface.

U.S. application Ser. No. 11/201,291 to Li, et al., filed Aug. 11, 2005 and U.S. application Ser. No. 11/201,292 to Li, et al., filed Aug. 11, 2005 provide methods and apparatuses for reducing microlens surface reflection by providing a graded index of reflection at the surface of the microlens. Their disclosures are hereby incorporated by reference. Additional arrangements for reducing reflection and refraction are desired.

### BRIEF DESCRIPTION OF THE DRAWINGS

FIG. 1a is a graph of depth vs. indices of refraction at the air-microlens interface of a conventional microlens of prior art;

FIG. 1b is a desirable graph of depth vs. indices of refraction at the air-microlens interface of a microlens;

FIG. 2 is a cross-section of an embodiment of the microlens at an initial stage of fabrication;

FIG. 3 is a cross-section of the microlens of FIG. 2 at a subsequent stage of fabrication;

FIG. 4a is a cross-section of the microlens of FIG. 3 at a subsequent stage of fabrication;

FIG. 4b is a cross-section of a pixel array employing a plurality of microlenses in accordance with an embodiment of the invention;

FIG. 5 a block diagram of an imager employing an array of microlenses constructed in accordance with an embodiment of the invention; and

FIG. 6 is a block diagram of a system, e.g., a digital camera, employing an imager in accordance with an embodiment of the invention.

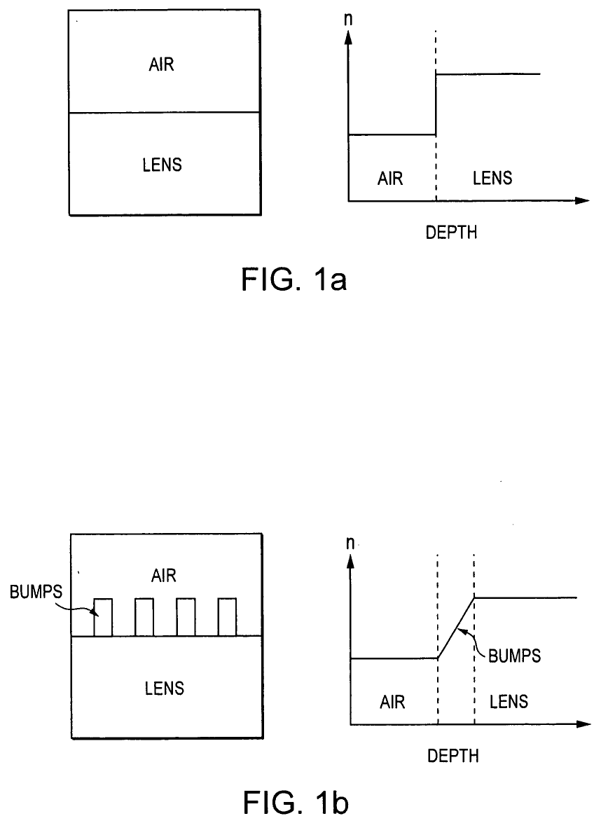

### DETAILED DESCRIPTION OF THE INVENTION

In the following detailed description, reference is made to the accompanying drawings which form a part hereof and illustrate a specific embodiment by which the invention may be practiced. It should be understood that like reference-numerals represent like-elements throughout the drawings. This embodiment is described in sufficient detail to enable those skilled in the art to practice the invention, and it is to be understood that other embodiments may be utilized, and that structural, logical and electrical changes may be made.

The term “substrate” is to be understood as including silicon-on-insulator (SOI) or silicon-on-sapphire (SOS) technology, doped and undoped semiconductors, epitaxial layers of silicon supported by a base semiconductor foundation, and other semiconductor structures. Furthermore, when reference is made to a “substrate” in the following description, previous process steps may have been utilized to form regions or junctions in the base semiconductor structure or foundation. In addition, the semiconductor need not be silicon-based, but could be based on silicon-germanium, germanium, or gallium arsenide, for example.

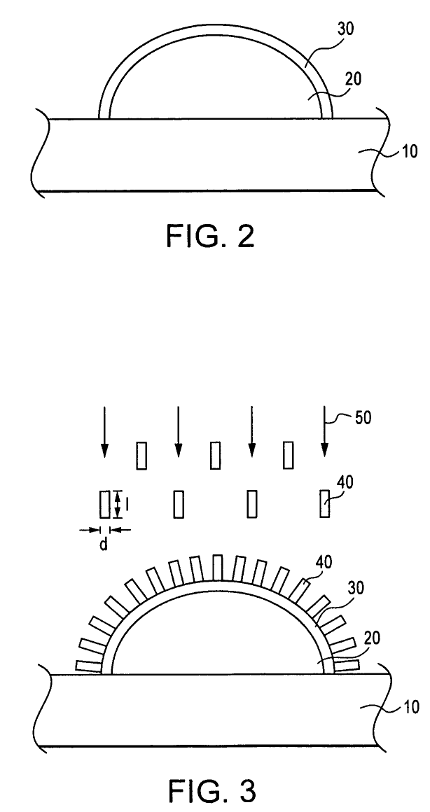

Referring now to the drawings, where like elements are designated by like reference numerals, FIG. 2 illustrates an embodiment of the invention at an initial stage of fabrication. A microlens 20 is formed over a layer 10 provided over a substrate on which pixels containing photosensors are formed. The microlens may be formed of any material used to form microlenses, such as photoresist polymers, oxides or nitrides. A adhesive layer 30 is formed on the surface of the microlens 20. The adhesive layer 30 is formed of a heat-curable or UV-curable adhesive material. The adhesive layer 30 may be applied by vapor priming or spraying an adhesive material over the surface of the microlens 20.

Fibers 40 are then propelled in an air stream 50 toward the adhesive layer 30 on the microlens 20, as shown in FIG. 3. The fibers 40 maybe of any transparent fiber material such as glass or polymer. The fibers 40 have a diameter, d, of about less than about 400 nm and a length, l, in the range of about 500 nm to about 2000 nm. The fibers 40 cover about 50-100% of the surface area of the microlens 20. Although the fibers 40 are shown to have substantially the same length in FIG. 3, it should be noted that the fibers may have varying lengths within the aforementioned range. One end of the fibers 40 embed themselves in the adhesive layer 30 and the fibers stand in random directions. Many fibers 40 embed themselves in the adhesive layer 30 at angles that are not perpendicular to the surface of the microlens 20 and, in fact, some fibers 40 may stick to the adhesive layer 30 along their length rather than at one end. The effect of these fibers is negligible and will not effect the optical properties of the microlens 20 because of their transparent nature and their sub-wavelength size.

Moreover, because the transparent fibers 40 on the surface of the microlens 20 themselves bring the refractive index at the surface of the microlens closer to that of air, the index of refraction of the fiber material is not of great importance. So long as the fibers have the dimensions and coverage as described above, they perform that function.

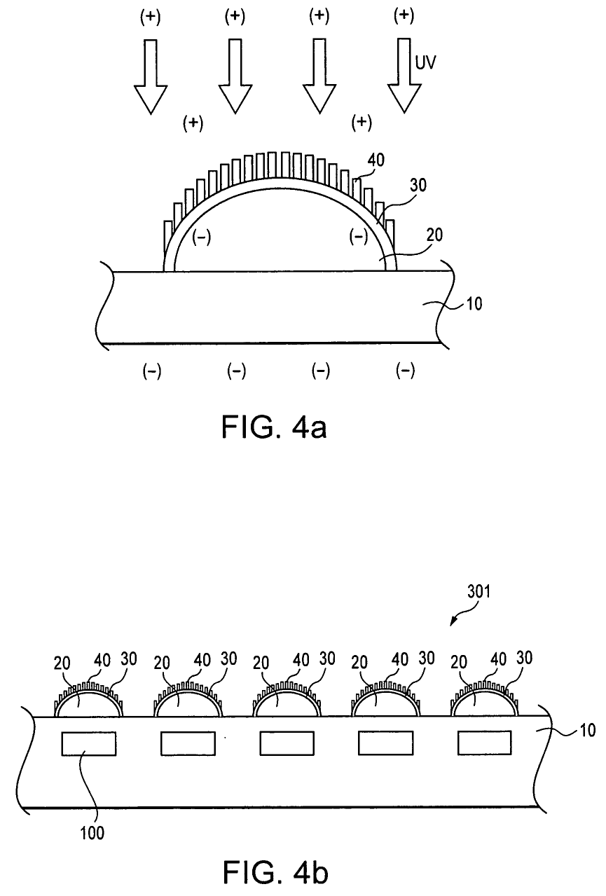

The fibers 40 are then placed in an aligned arrangement such that they stand generally at a 90 degree angle to the surface of the layer 10, as shown in FIG. 4a. In order to line up the fibers 40 in a generally vertically-oriented arrangement, the fibers 40 are subjected to an electric field generated by high DC voltage, such as a field generated by power generators used for electrostatic flocking in the textile industry. An electric field is generated and the substrate 10 and associated microlens 20 is placed within the field.

Once placed in the field, all of fibers 40 become charged positively (or negatively, depending upon the direction of the field) at one end and begin to repel one another. In order to maximize the distance away from each other, the fibers 40 stand up vertically. The adhesive layer 30 is then subjected to UV radiation or heat radiation to cure the adhesive layer 30, thereby affixing the fibers 40 to the adhesive layer 30 in the aligned orientation.

The formation of vertical fibers on the surface of a microlens creates a microlens outer surface with an index of refraction closer to the index of air to reduce reflection caused by the sharp reflective index change from air to the microlens 20. A gradual index change is obtained at the surface by providing a microlens 20 having a rough lens-air surface. Therefore, reflection from the interface between the two media can be reduced by a better matching of their indices of refraction. By providing an outer layer on a lens having an index of refraction closer to that of the surrounding medium, such as that of air, reflection is reduced and the efficiency and accuracy of the lens is improved.

FIG. 4b is a cross-section of a pixel array 301 having an array of pixels 100 and a microlens 20 having an adhesive layer 30 and fibers 40 over each pixel 100.

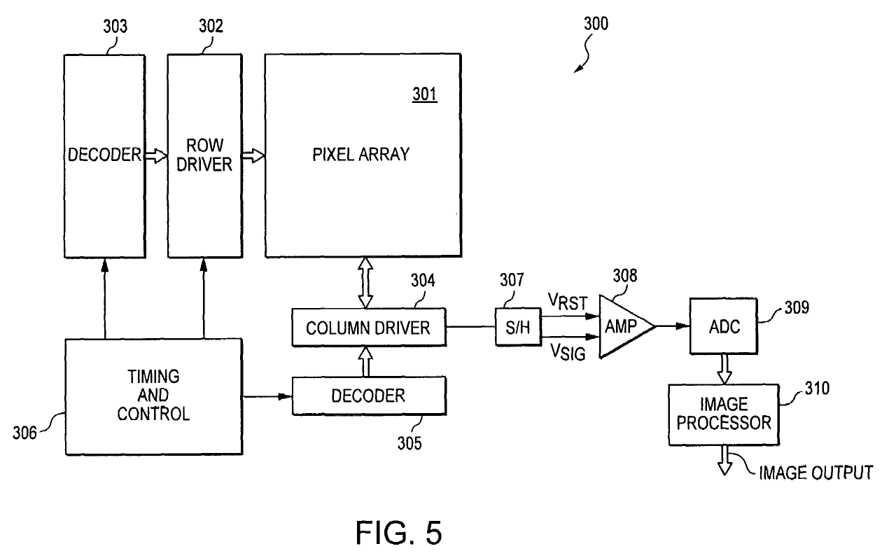

FIG. 5 illustrates a simplified block diagram of an imager 300, for example a CMOS imager, employing a pixel array having a layer of microlenses constructed as described above over the array. Pixel array 301 comprises a plurality of pixels containing respective photosensors arranged in a predetermined number of columns and rows. The row lines are selectively activated by the row driver 302 in response to row address decoder 303 and the column select lines are selectively activated by the column driver 304 in response to column address decoder 305. Thus, a row and column address is provided for each pixel cell.

The CMOS imager 300 is operated by a timing and control circuit 306, which controls decoders 303, 305 for selecting the appropriate row and column lines for pixel readout, and row and column driver circuitry 302, 304, which apply driving voltages to the drive transistors of the selected row and column lines. The pixel signals, which typically include a pixel reset signal Vrst and a pixel image signal Vsig for each pixel are sampled by sample and hold circuitry 307 associated with the column driver 304. A differential signal Vrst−Vsig is produced for each pixel, which is amplified by an amplifier 308 and digitized by analog-to-digital converter 309. The analog to digital converter 309 converts the analog pixel signals to digital signals, which are fed to an image processor 310 form a digital image in accordance with the present invention.

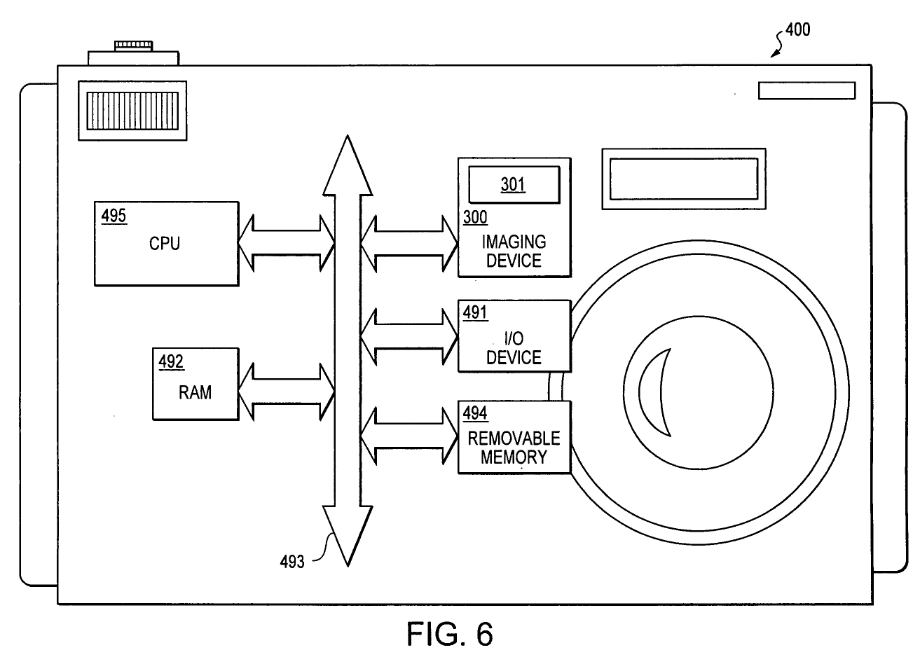

FIG. 6 shows in simplified form a typical processor system 400 which includes an imaging device 300 (FIG. 5) employing a pixel array having a layer of microlens constructed as described above. The processor system 400 is exemplary of a system having digital circuits that could include imaging device 300. Without being limiting, such a system could include a computer system, still or video camera system, scanner, machine vision, vehicle navigation, video phone, surveillance system, auto focus system, star tracker system, motion detection system, image stabilization system, and other systems employing an imaging device.

The processor system 400, for example a digital still or video camera system, generally comprises a lens for focusing an image on pixel array 301, central processing unit (CPU) 495, such as a microprocessor which controls camera and one or more image flow functions, which communicates with one or more input/output (I/O) devices 491 over a bus 493. Imaging device 300 also communicates with the CPU 495 over bus 493. The system 400 also includes random access memory (RAM) 492 and can include removable memory 494, such as flash memory, which also communicates with CPU 495 over the bus 493. Imaging device 300 may be combined with the CPU, with or without memory storage on a single integrated circuit or on a different chip. Although bus 493 is illustrated as a single bus, it may be one or more busses or bridges or other communication paths used to interconnect the system components.

While an embodiment has been described and illustrated above, it should be understood that it has been presented by way of example, and not limitation. For example, although the invention has been described and illustrated in conjunction with pixel structures and a pixel array readout circuit associated with CMOS imagers, it is not so limited and may be employed with any solid state imager pixel structure and associated array readout circuit. It will be apparent to that various changes in form and detail can be made to the described embodiment.

1. A microlens comprising:
a lens body; and
a plurality of fibers each having one end secured to a surface of the microlens body.

2. The microlens of claim 1, wherein the fibers are light-transparent.

3. The micro lens of claim 1, wherein the fibers have a diameter less than about 400 nm.

4. The microlens of claim 1, wherein each of the plurality of fibers has a length in the range of about 500 nm to about 2000 nm.

5. The microlens of claim 1, wherein about 50 to less than 100 percent of the surface area of the microlens body is covered with the fibers.

6. The microlens of claim 1, further comprising an adhesive layer for fixing the plurality of fibers to the lens body.

7. The microlens of claim 7, wherein the adhesive layer is a cured adhesive layer.

8. The microlens of claim 1, wherein the fibers are vertically aligned on the surface.

9. (canceled)

10. A pixel array comprising:
a plurality of photosensors; and
a plurality of microlenses associated with the photosensors, wherein the microlenses each have a body portion and an anti-reflective surface layer on the body portion comprising a plurality of aligned fibers having ends fixed to the body portion.

11. The pixel array of claim 10, wherein the anti-reflective layer provides the microlens with an index of refraction closer to the index of refraction of air than the index of refraction of the microlens body.

12. The pixel array of claim 10, further comprising an adhesive coating on the surface of each microlens body for adhering the fibers to the surface of the body portion.

13. An imager device comprising:
a plurality of pixels formed on a substrate;
a plurality of microlenses formed over the plurality of pixels, wherein each microlens has a fiber-coated surface; and
a readout structure for reading out signals from the plurality of pixels and for providing an image based on the signals.

14. The imager device of claim 13, wherein the fiber-coated surface of the microlens comprises an adhesive coating and a plurality of vertically aligned fibers.

15-20. (canceled)

21. A method of forming a pixel array, comprising:
forming a plurality of pixels on a substrate;
forming a plurality of microlenses over the plurality of pixels;
forming a plurality of vertically aligned fibers on the surface of the microlenses.

22. The method of claim 21, wherein the step of forming a plurality of fibers further comprises fixing the plurality of fibers in a vertically-oriented arrangement on the surface of each of the microlenses.

23. (canceled)

24. The method of claim 21, wherein the step of forming a plurality of fibers includes forming an adhesive coating over the plurality of microlenses and propelling the plurality of fibers in an air-stream toward the adhesive coating such that the ends of the fibers attach to the surface of the microlens.

25. (canceled)

26. The method of claim 21, wherein the step of forming a plurality of fibers includes placing the pixel array in an electric field.

27. The method of claim 26, further comprising providing the fibers with a same electrical charge on one end of the fibers such that the fibers repel each other.

28. (canceled)

29. A method of forming a microlens comprising:
providing an adhesive layer on a surface of a microlens;
providing fibers on the adhesive coating;
causing the fibers to stand vertically on the microlens; and
curing the adhesive layer.

30. The method of claim 29, wherein the step of providing an adhesive layer comprises either applying a vapor prime of adhesive material or spraying an adhesive material onto the surface of a microlens.

31. (canceled)

32. The method of claim 29, wherein the step of providing fibers comprises propelling fibers in an air- stream toward the adhesive layer.

33. The method of claim 32, wherein the step of providing fibers further includes embedding one end of each fiber into the adhesive layer.

34. The method of claim 29, wherein the step of causing the fibers to stand vertically on the microlens comprises placing the microlens in an electric field.

35. The method of claim 34, wherein the fibers are charged to a predetermined polarity by placing the microlens in the electric field.

36. (canceled)
